(19) United States
(12) Patent Application Publication
(10) Pub. No.: US 2015/0346894 A1
(43) Pub. Date: Dec. 3, 2015

(54) COMPUTING DEVICE THAT IS RESPONSIVE TO USER INTERACTION TO COVER PORTION OF DISPLAY SCREEN

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/289,991

(22) Filed: May 29, 2014

(51) Int. Cl. G06F 3/041; G09G 5/00

(52) U.S. Cl. CPC G06F 3/0416; G06F 3/0412; G09G 5/003; G09G 2354/00; G09G 2330/027; G09G 2330/021; G09G 2380/14

(57) ABSTRACT

A computing device includes a housing and a display assembly having a screen. The housing at least partially circumvents the screen so that the screen is viewable and a set of touch sensors are provided with the display assembly. A processor is provided within the housing to detect a user interaction with the set of touch sensors. The processor further determines, based on the user interaction, that at least a threshold percentage of the screen of the display assembly is covered and executes one or more instructions based, at least in part, upon determining that the at least threshold percentage of the screen is covered. For example, the one or more instructions may include instructions for powering off the computing device, displaying a screen saver on the screen, placing the computing device in a sleep mode, and/or changing a state of the screen of the display assembly.

### TECHNICAL FIELD

Examples described herein relate to a computing device that is responsive to a user interaction in which at least a portion of display screen is covered.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reader device or other electronic personal display device, for use with one or more embodiments described herein.

FIGS. 3A-3B illustrate an e-reader device capable of detecting palm-touch inputs, in accordance with some embodiments.

FIG. 4 illustrates an e-reader system for displaying paginated content, according to one or more embodiments.

FIG. 5 illustrates a method of operating an e-reader device using palm-touch inputs, according to one or more embodiments.

### DETAILED DESCRIPTION

Embodiments described herein provide for a computing device that can detect a user's palm covering a display of the computing device. More specifically, the computing device may interpret such user (e.g., palm-touch) interaction as a particular type of input. For example, the input may be provided by a user covering at least a threshold percentage and/or portion of the display with an open palm or hand. The computing device may respond to palm-touch inputs, for example, by powering off, entering a sleep mode, displaying a screen saver, and/or otherwise altering a state of the device or the display.

According to some embodiments, a computing device includes a housing and a display assembly having a screen. The housing at least partially circumvents the screen so that the screen is viewable and a set of touch sensors are provided with the display assembly. A processor is provided within the housing to detect a user interaction with the set of touch sensors. The processor further determines, based on the user interaction, that at least a threshold percentage of the screen of the display assembly is covered and executed one or more instructions based, at least in part, upon determining that the at least threshold percentage of the screen is covered. For example, the one or more instructions may include instructions for power off the computing device, displaying a screen saver on the screen of the display assembly, placing the computing device in a sleep mode, powering off the display assembly, and/or otherwise changing a state of the screen of the display assembly.

For some embodiments, the processor may execute the one or more instructions if at least a designated threshold (e.g., 50%) of the display screen is covered. Further, for some embodiments, the set of touch sensors may be integrated with the screen of the display assembly. Thus, the processor may detect the user interaction with the set of touch sensors by detecting user contact with a plurality of the touch sensors, concurrently. In yet another embodiment, the processor may determine a duration of the user interaction with the set of touch sensors. For example, the processor may execute the one or more instructions upon determining that the at least threshold percentage of the screen remains covered for at least a threshold duration.

Among other benefits, examples described herein enable a user to power off and/or otherwise interact with a personal display device, such as an e-reader device, in a discrete and intuitive manner. For example, a user reading a confidential document on an e-reader device may instinctively cover up the display screen when others are around. When the user's palm is held over the surface of the display screen (e.g., covering a majority of the screen) for a given duration, it is unlikely that the user is reading (or is even able to read) the contents displayed on the screen. Therefore, the e-reader device may interpret palm-touch inputs as triggers for turning off the device and/or display (e.g., to conserve power), or otherwise changing a state of the display.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

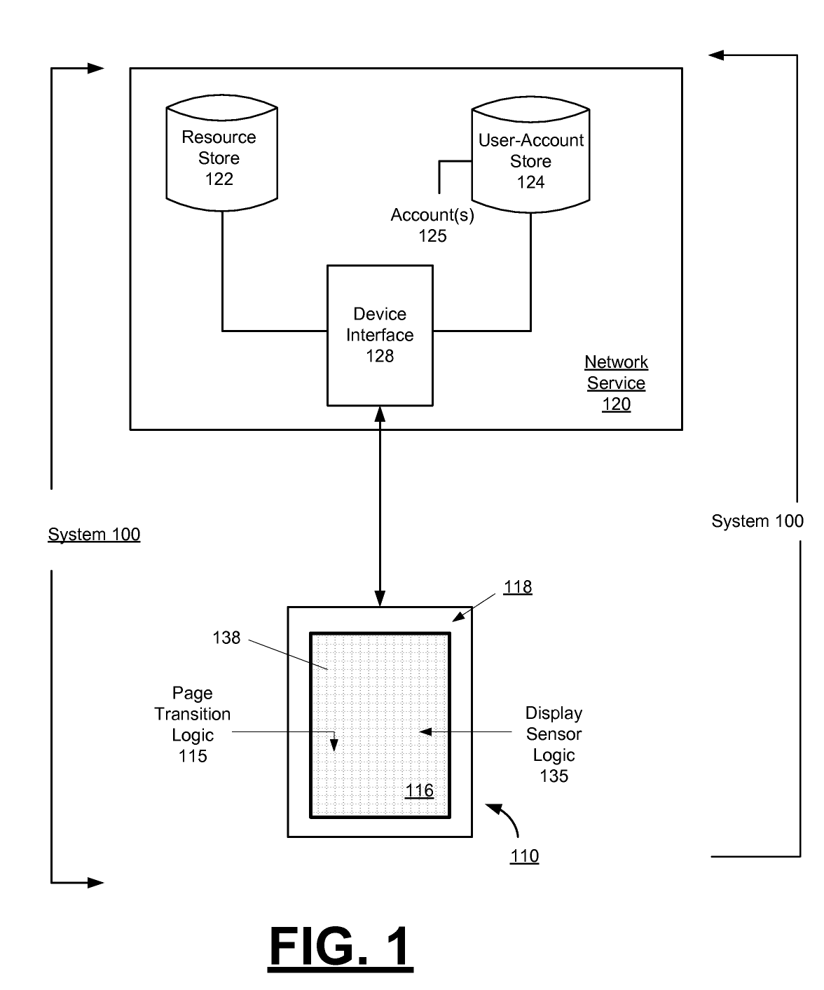

FIG. 1 illustrates a system 100 for utilizing applications and providing e-book services on a computing device, according to an embodiment. In an example of FIG. 1, system 100 includes an electronic display device, shown by way of example as an e-reader device 110, and a network service 120. The network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application that receives files or streaming data from the network service 120. By way of example, the e-reader device 110 can be equipped with hardware and software to optimize certain application activities, such as reading electronic content (e.g., e-books). For example, the e-reader device 110 can have a tablet-like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to an example of FIG. 1, e-reader device 110 can include a display screen 116 and a housing 118. In an embodiment, the display screen 116 is touch-sensitive, to process touch inputs including gestures (e.g., swipes) and palm-touch inputs. For example, the display screen 116 may be integrated with one or more touch sensors 138 to provide a touch sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116.

According to some embodiments, the e-reader device 110 includes display sensor logic 135 to detect and interpret user input made through interaction with the touch sensors 138. By way of example, the display sensor logic 135 can detect a user making contact with the touch sensing region of the display 116. For some embodiments, the display sensor logic 135 may interpret simultaneous contact with multiple touch sensors 138 as a particular type of user input. For example, the multi-sensor contact may correspond to a user covering a substantial portion and/or surface area of the display 116 (e.g., with the user's palm or open hand). Specifically, the user (e.g., palm-touch) input may be interpreted as a change in state of the device 110 and/or of the display 116. For example, a user may cover the display 116 with an open palm to power off the device 110 and/or the display 116 (e.g., by placing the device 110 in a sleep mode). Alternatively, or in addition, the user may place a palm over the display 116 to activate a screen saver on the display 116 and/or otherwise after a state of the display 116 such as, for example, launching and/or closing a book, application, menu, or sub-menu.

In some embodiments, the e-reader device 110 includes features for providing functionality related to displaying paginated content. The e-reader device can include page transitioning logic 115, which enables the user to transition through paginated content. The e-reader device can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display 116. For example, the user can trigger a page turn (e.g., a forward or backward page transition) input by tapping the surface of the display 116. Alternatively, and/or additionally, the user may trigger a page turn input by swiping the surface of the display 116 (e.g., in the direction of the desired page transition).

Hardware Description

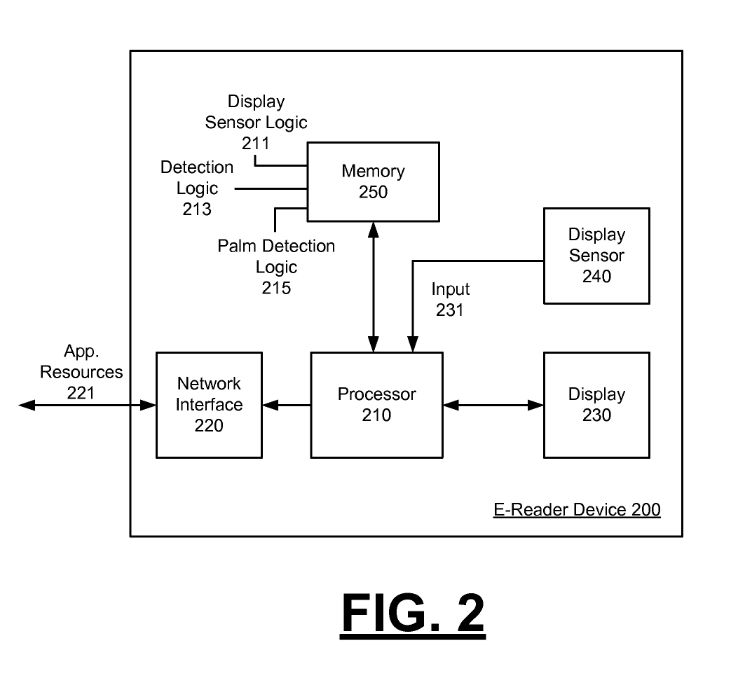

FIG. 2 illustrates an example of an e-reader device 200 or other electronic personal display device, for use with one or more embodiments described herein. In an example of FIG. 2, an e-reader device 200 can correspond to, for example, the device 110 as described above with respect to FIG. 1. With reference to FIG. 2, e-reader device 200 includes a processor 210, a network interface 220, a display 230, one or more display sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources 221, such as e-books or media files, that the user elects to purchase or otherwise download from the network service 120. The application resources 221 that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. For example, in some embodiments, the display sensor components 240 may be integrated with the display 230. In other embodiments, the display sensor components 240 may be provided (e.g., as a layer) above or below the display 230 such that each of the display sensor components 240 tracks a region of the display 230. Further, in some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the display sensor components 240, the display 230, and/or other input mechanisms (e.g., buttons, keyboard, mouse, microphone, etc.). With reference to examples described herein, the processor 210 can respond to input 231 from the display sensor components 240. In some embodiments, the processor 210 responds to inputs 231 from the display sensor components 240 in order to facilitate or enhance e-book activities such as powering off the device 200 and/or display 230, activating a screen saver, and/or otherwise altering a state of the display 230.

In some embodiments, the memory 250 may store display sensor logic 211 that monitors for user interactions detected through the display sensor components 240, and further processes the user interactions as a particular input or type of input. In an alternative embodiment, the display sensor logic 211 may be integrated with the display sensor components 240. For example, the display sensor components 240 can be provided as a modular component that includes integrated circuits or other hardware logic, and such resources can provide some or all of the display sensor logic (see also display sensor logic 135 of FIG. 1). For example, integrated circuits of the display sensor components 240 can monitor for palm-touch user interactions (e.g., by detecting that a threshold percentage of the display 230 and/or the display sensor components 240 is covered) and/or interpret the placement of a user's palm over the surface of the display 230 as being a particular type of input. In variations, some or all of the display sensor logic 211 may be implemented with the processor 210 (which utilizes instructions stored in the memory 250), or with an alternative processing resource.

In one implementation, the display sensor logic 211 includes detection logic 213 and palm detection logic 215. The detection logic 213 implements operations to monitor for user contact on a surface of the display 230 coinciding with the placement of the sensor components 240. The palm detection logic 215 detects and correlates a covering of the sensor components 240 (e.g., with a user's palm and/or other objects) as a particular type of input or user action. For some embodiments, the palm detection logic 215 may register a palm-touch input only if the sensor components 240 remain covered for at least a threshold duration (e.g., 1.5-2 seconds). For example, this may ensure that a user actually intends to power off the device 200 and/or display 230, rather than inadvertently covering up the sensors components 240.

For some embodiments, the palm detection logic 215 may detect the presence of a user's palm. For example, the palm detection logic 215 may determine an input capacitance associated with the user's palm (e.g., and fingers), and correlate that input capacitance with a palm-sensing threshold for detecting palm-touch inputs. Alternatively, the palm detection logic 215 may detect the shape and/or outline of a user's palm (e.g., and fingers) based on the pattern of sensor components 240 registering touch contact. For other embodiments, the palm detection logic 215 may detect whether a threshold percentage (e.g., 50%) of the surface area of the display 240 is covered or otherwise obfuscated by an external object such as, for example, the user's palm. For example, the palm detection logic 215 may determine whether the user's palm is in contact with, or otherwise covering, a threshold number of the sensor components 240, concurrently.

Palm-Touch Detection

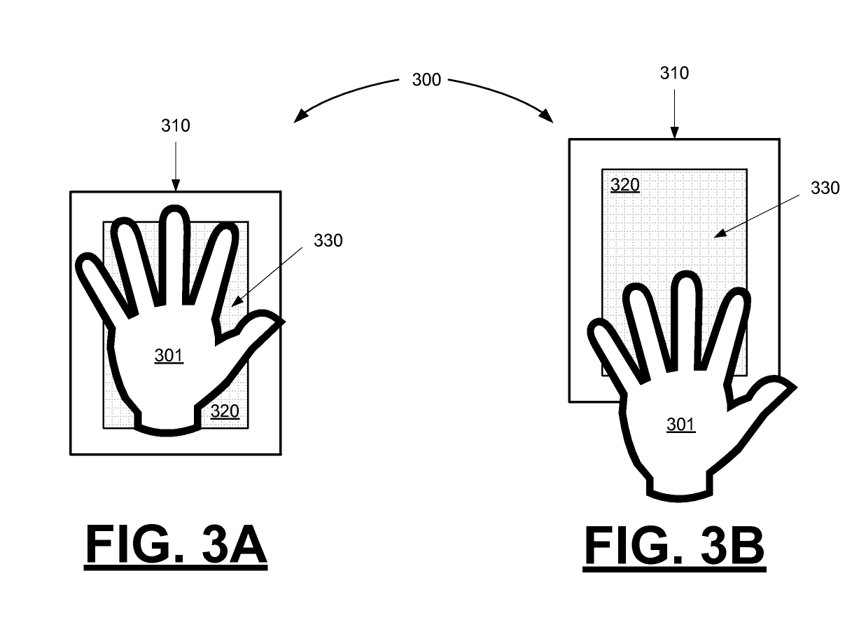

FIGS. 3A-3B illustrate an e-reader device 300 capable of detecting palm-touch inputs, in accordance with some embodiments. The e-reader device 300 includes a housing 310 and a display screen 320. The e-reader device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the display screen 320. Specifically, the touch sensing region 330 may coincide with the integration of touch-sensors with the display screen 320. For some embodiments, the touch sensing region 330 may substantially encompass a surface of the display screen 320. Further, the e-reader device 300 can integrate one or more types of touch-sensitive technologies in order to provide touch-sensitivity on the touch sensing region 330 of the display screen 320. It should be appreciated that a variety of well-known touch sensing technologies may be utilized to provide touch-sensitivity at either the touch sensing region 330.

By way of example, touch sensors used with the touch sensing region 330 can utilize resistive touch sensors; capacitive touch sensors (using self and/or mutual capacitance); inductive touch sensors; and/or infrared touch sensors. For example, touch sensing region 330 can be employed using resistive sensors, which can respond to pressure applied to the surface of the display screen 320 in areas coinciding with the touch sensing region 330.

In a variation, the touch sensing region 330 can be implemented using a grid pattern of electrical elements which can detect capacitance inherent in human skin. Alternatively, the touch sensing region 330 can be implemented using a grid pattern of electrical elements which are placed over or just beneath the surface of the display screen 320, and which deform sufficiently on contact to detect touch from an object such as a finger and/or palm. More generally, touch-sensing technologies for implementing the touch sensing region 330 can employ resistive touch sensors, capacitive touch sensors (using self and/or mutual capacitance), inductive touch sensors, and/or infrared sensors.

For some embodiments, the touch sensing region 330 may include a number of sensor components that are capable of detecting the presence of a user's palm 301. For example, the touch sensing region 330 may be formed from an arrangement (e.g., pattern) of touch sensors that can detect the shape and/or outline of the user's palm 301 when placed over the surface of the display screen 320 (e.g., as shown in FIG. 3A). Alternatively, the touch sensing region 330 may detect the presence of the user's palm 301 when a total input capacitance detected by one or more touch sensors exceeds a threshold input capacitance associated with the user's palm 301. The threshold input capacitance may be a predetermined threshold and/or based on the capacitance of an actual user's palm (e.g., determined through a registration process). It should be noted that the touch sensing region 330 may not register a palm-touch input if the user's palm 301 (or at least a substantial portion thereof) does not make contact with the touch sensing region 330 (e.g., as shown in FIG. 3B).

For other embodiments, the touch sensing region 330 may include a number of sensor components that are capable of detecting a percentage (e.g., proportion) of the display screen 320 that is covered by the user's palm or other objects. For example, rather than detect the user's palm 301, the touch sensing region 330 may detect that a proportion (e.g., ≧50%) of the display screen 320 that is covered or otherwise obfuscated by the user's palm 301 (e.g., as shown in FIG. 3A). Such embodiments may allow palm-touch inputs to be triggered in response to the placement of other objects over the touch sensing region 330 (e.g., not just the user's palm 301). The percent-coverage threshold may be a predetermined threshold and/or based on the size of an actual user's palm (e.g., determined through a registration process). It should be noted that the touch sensing region 330 may not register a palm-touch input if the user's palm 301 (and/or other object) does not cover at least the threshold percentage of the display screen 320 (e.g., as shown in FIG. 3B).

While the examples of FIGS. 3A-3B illustrate a particular touch sensing region 330 provided on the surface of the display screen 320, variations can provide for additional and/or alternative touch sensing regions. For example, other surfaces of the housing 310 may be integrated with touch sensors in order to enable touch-sensitivity at any location of, for example, the front, back, and/or sides of the device 300.

Page Transition Functionality

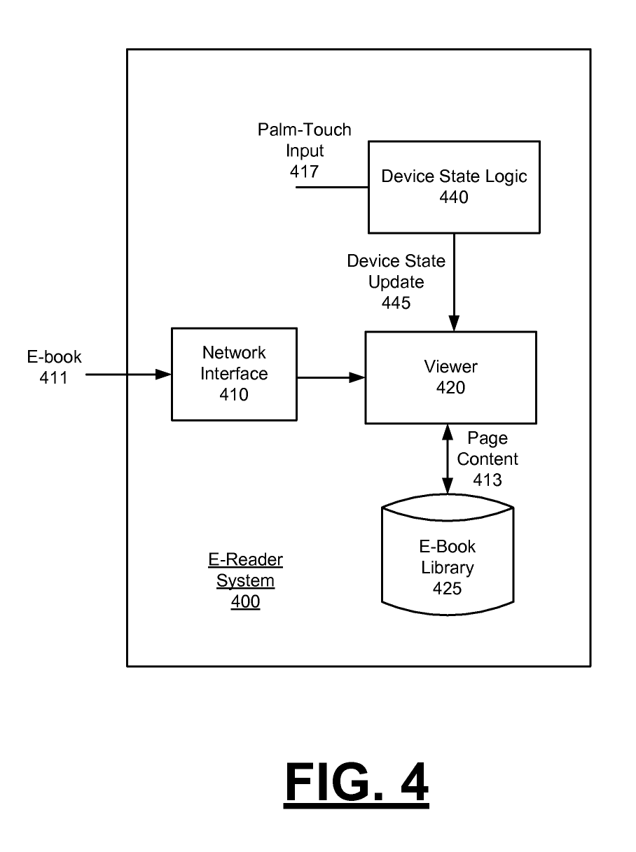

FIG. 4 illustrates an e-reader system 400 for displaying paginated content, according to one or more embodiments. An e-reader system 400 can be implemented as, for example, an application or device, using components that execute on, for example, an e-reader device such as shown with examples of FIGS. 1, 2, and 3A-3B. Furthermore, an e-reader system 400 such as described can be implemented in a context such as shown by FIG. 1, and configured as described by an example of FIG. 2 and/or FIGS. 3A-3B.

In an example of FIG. 4, a system 400 includes a network interface 410, a viewer 420 and device state logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reader device (e.g., see memory 250 of e-reader device 200).

The viewer 420 can access page content 413 from a selected e-book, provided with the e-book library 425. The page content 413 can correspond to one or more pages that comprise the selected e-book. The viewer 420 renders one or more pages on a display screen at a given instance, corresponding to the retrieved page content 413. The page state can correspond to a particular page, or set of pages that are displayed at a given moment.

The device state logic 440 can be provided as a feature or functionality of the viewer 420. Alternatively, the device state logic 440 can be provided as a plug-in or as independent functionality from the viewer 420. The device state logic 440 can signal device state updates 445 to the viewer 420. The device state update 445 can cause the viewer 420 to change or after its current display state. For example, in specifying the device state update 445, the device state logic 440 can provide instructions for a device shutoff, display shutoff, and/or screen saver. The device state update 445 for a device shutoff causes the entire system 400, including the viewer 420, to shut down and/or power off. The device state update 445 for a display shutoff causes only the viewer 420 to power off, thus placing the system 400 in a “sleep” mode. Further, the device state update 445 for a screen saver causes a screen saver to be displayed on the viewer 420. It should be noted that other device state updates 445 may also be provided such as, for example, launching and/or closing a book, application, menu, or sub-menu.

According to some embodiments, the device state logic 440 can be responsive to different kinds of input, including a palm-touch input action 417 which signifies a state change. For example, the palm-touch input 417 can be provided by the user placing a palm (or other object) over a display surface of the e-reader system 400, such that a threshold percentage (e.g., ≧50%) of the display surface is covered or otherwise obfuscated by the user's palm. For some embodiments, device state logic 440 may output the device state update 445 only if a duration of the palm-touch input 417 exceeds a threshold duration. For example, the e-reader system 400 may proceed to shut down only if the display screen remains covered (e.g., by the user's palm and/or other objects) for at least 1.5 to 2 seconds.

Methodology

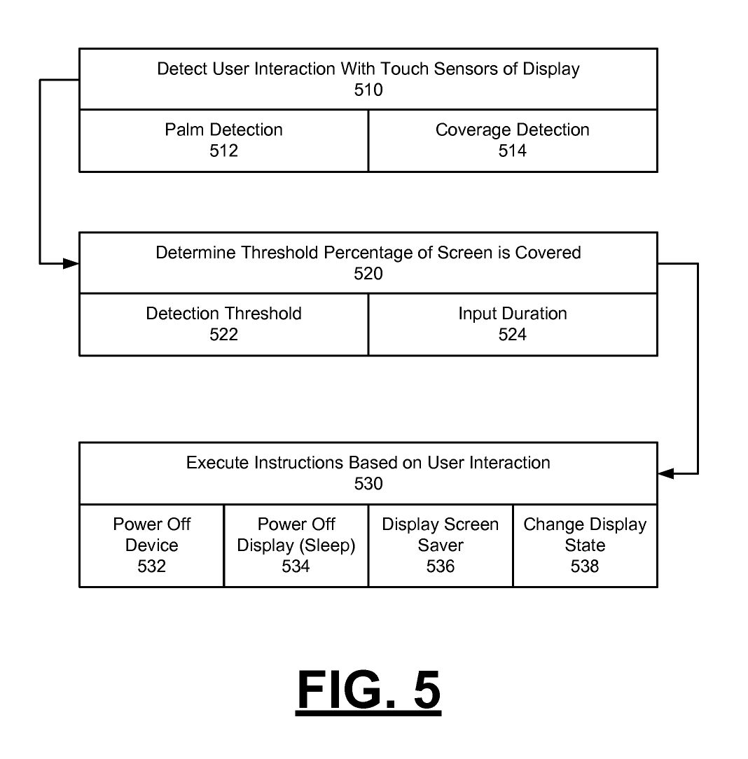

FIG. 5 illustrates a method of operating an e-reader device using palm-touch inputs, according to one or more embodiments. In describing an example of FIG. 5, reference may be made to components such as described with FIGS. 2-3 for purposes of illustrating suitable components for performing a step or sub-step being described.

With reference to an example of FIG. 2, the e-reader device 200 may detect a user interaction with one or more touch sensors provided (or otherwise associated) with a display of the e-reader device 200 (510). For example, the processor 210 can receive inputs 231 from the display sensor components 240. More specifically, the placement of the sensor components 240 may coincide with one or more touch sensing regions on the surface of the display 230. As shown in FIG. 3A, the user interaction may correspond with the placement of a user's palm 301 over the surface of the display 320.

For some embodiments, the processor 210, in executing the palm detection logic 215, may detect the presence of a user's palm (512). For example, with reference to FIG. 3A, the touch sensing region 330 may detect the shape and/or outline of the user's palm 301 when placed over the surface of the display screen 320. Alternatively, the touch sensing region 330 may detect the input capacitance of the user's palm 301 when placed over the surface of the display screen 320. For other embodiments, the processor 210, in executing the palm detection logic 215, may detect a coverage area or percentage of the display screen that is covered by the user's palm and/or other objects (514). For example, with reference to FIG. 3A, the touch sensing region 330 may detect a proportion of the display screen 320 that is covered or otherwise obfuscated by the user's palm 301.

The e-reader device 200 may subsequently determine that at least a threshold percentage of the display 230 is covered by the user's palm (520). For example, the processor 210 may determine, based on the received inputs 231, that the user's entire palm (or at least a substantial portion thereof) is covering the display 230. Alternatively, the processor 210 may determine that a substantial portion (e.g., ≧50%) of the total surface area of the display 230 is covered by the user's palm. For example, a user interaction (e.g., palm placement) such as shown in FIG. 3A may trigger a palm-touch input whereas a user interaction such as shown in FIG. 3B may not trigger a palm-touch input.

For some embodiments, the processor 210, in executing the palm detection logic 215, may determine whether the detected user interaction satisfies a particular detection threshold (522). For example, the processor 210 may compare a detected input capacitance (e.g., based on the user interaction) with an input-capacitance threshold. More specifically, the input-capacitance threshold may be a predetermined threshold and/or based on a preregistered capacitance of the user's palm (e.g., determined through a registration process). Alternatively, and/or additionally, the processor 210 may compare the coverage area of the display 230 (e.g., based on the user interaction) with a percent-coverage threshold. More specifically, the percent-coverage threshold may be a predetermined threshold and/or based on a preregistered size of the user's palm (e.g., determined through a registration process).

Further, for some embodiments, the processor 210 may determine whether a duration of the user interaction satisfies a particular threshold duration (524). For example, the palm detection logic 215 may register a palm-touch input only if the sensor components 240 remain covered for at least the threshold duration (e.g., 1.5-2 seconds). This may ensure that a user actually intends to power off the device 200 and/or display 230, rather than inadvertently covering up the sensor components 240.

The e-reader device 200 may then execute a set of instructions based on the user interaction (530). For example, the processor 210 may carry out one or more operations on the device 200 upon detecting a palm-touch input for at least the threshold duration. Various operations may be carried out in response to the user placing a palm over (or otherwise covering) the surface of the display 230. For some embodiments, the processor 210 may power off the entire e-reader device 200 (532). For other embodiments, the processor 210 may power off only the display 230, thus placing the e-reader device 200 in a sleep mode (534). In yet another embodiment, the processor 210 may activate a screen saver on the display 230 (536). Still further, for some embodiments, the processor 210 may change or after a state of the display (538). For example, the processor 210 may proceed by launching and/or closing a book, application, menu, or sub-menu.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a screen;
a housing that at least partially circumvents the screen so that the screen is viewable;
a set of touch sensors provided with the display assembly; and
a processor provided within the housing, the processor operating to:
detect a user interaction with the set of touch sensors;
determine, based on the user interaction, that at least a threshold portion of the screen of the display assembly is covered; and
execute one or more instructions based, at least in part, upon determining that the at least threshold portion of the screen is covered.

2. The computing device of claim 1, wherein the one or more instructions include instructions for powering off the computing device.

3. The computing device of claim 1, wherein the one or more instructions include instructions for placing the computing device in a sleep mode.

4. The computing device of claim 1, wherein the one or more instructions include instructions for displaying a screen saver on the screen of the display assembly.

5. The computing device of claim 1, wherein the one or more instructions include instructions for changing a state of the screen of the display assembly.

6. The computing device of claim 1, wherein the one or more instructions include instructions for powering off the display assembly.

7. The computing device of claim 1, wherein the threshold portion is fifty percent.

8. The computing device of claim 1, wherein the set of touch sensors are integrated with the screen of the display assembly.

9. The computing device of claim 8, wherein the processor is to detect the user interaction with the set of touch sensors by:
detecting user contact with a plurality of the touch sensors, concurrently.

10. The computing device of claim 1, wherein the processor is to further:
determine a duration of the user interaction.

11. The computing device of claim 10, wherein the processor is to execute the one or more instructions upon determining that the at least threshold portion of the screen remains covered for at least a threshold duration.

12. A method for operating a computing device, the method being implemented by one or more processors and comprising:
detecting a user interaction with a set of touch sensors provided with a display assembly of the computing device;
determining, based on the user interaction, that at least a threshold portion of the screen of the display assembly is covered; and
executing one or more instructions based, at least in part, upon determining that the at least threshold portion of the screen is covered.

13. The method of claim 12, wherein the one or more instructions include instructions for powering off the computing device.

14. The method of claim 12, wherein the one or more instructions include instructions for displaying a screen saver on the screen of the display assembly.

15. The method of claim 12, wherein the one or more instructions include instructions for changing a state of the screen of the display assembly.

16. The method of claim 12, wherein the threshold portion is fifty percent.

17. The method of claim 16, wherein the set of touch sensors are integrated with the screen of the display assembly, and wherein detecting the user interaction with the set of touch sensors comprises:
detecting user contact with a plurality of the touch sensors, concurrently.

18. The method of claim 12, further comprising:
determining a duration of the user interaction.

19. The method of claim 18, wherein executing the one or more instructions comprises:
executing the one or more instructions upon determining that the at least threshold portion of the screen remains covered for at least a threshold duration.

20. A non-transitory computer-readable medium that stores instructions, that when executed by one or more processors, cause the one or more processors to perform operations that include:
detecting a user interaction with a set of touch sensors provided with a display assembly of the computing device;
determining, based on the user interaction, that at least a threshold portion of the screen of the display assembly is covered; and
executing one or more instructions based, at least in part, upon determining that the at least threshold portion of the screen is covered.
